(19) United States
(12) Patent Application Publication
(10) Pub. No.: US 2018/0210692 A1
(43) Pub. Date: Jul. 26, 2018

(54) SYNCHRONIZING METHOD FOR DISPLAY DEVICES

(71) Applicant: ELITEGROUP COMPUTER SYSTEMS CO.,LTD., Taipei City (TW)

(72) Inventor: Chen-Han LEE, Taipei City (TW)

(73) Assignee: ELITEGROUP COMPUTER SYSTEMS CO.,LTD., Taipei City (TW)

(21) Appl. No.: 15/584,722

(22) Filed: May 2, 2017

(30) Foreign Application Priority Data
Jan. 25, 2017 (TW) 106103066

(51) Int. Cl. G06F 3/14; H04N 5/073; G06F 13/10

(52) U.S. Cl. CPC G06F 3/1431; G09G 5/363; G06F 13/102; H04N 5/073

(57) ABSTRACT

A synchronizing method is applied to processors each installed with a control program, a player program and a combination thereof, and display devices each electrically connected to one of the processors. The method includes: defining the control program of one of the processors as a primary control program; defining a system time of the primary control program as a standard time for the player programs; by the primary control program sending a first play command instructing each player program to start playing image data at a time position corresponding to the standard time; by the primary control program sending a state command to instruct each player program to return a first decoding position; and by the primary control program determining, according to the first decoding positions, whether the image data played by one of the player programs is synchronous to the image data played by another one.

### CROSS-REFERENCE TO RELATED APPLICATIONS

This non-provisional application claims priority under 35 U.S.C. § 119(a) on Patent Application No(s). 106103066 filed in Taiwan, R.O.C. on Jan. 25, 2017, the entire contents of which are hereby incorporated by reference.

### TECHNICAL FIELD

The disclosure relates to a synchronizing method for display devices, more particularly to a method of controlling display devices to synchronously play image data.

### BACKGROUND

The advance of display technology has brought that many places, such as airports, cinemas, convenience stores, buses, schools, art galleries, shopping malls, hotels, government organizations, hospitals, banks or TV news stations, are usually disposed with a digital signage constituted by a number of display devices for the broadcast of various information to the public. For a digital signage constituted by a number of display devices in the art, each display device is disposed with a receiver, and these receivers are connected to a host computer via a matrixer. The host computer decodes an image to be played and sends the decoded image to the matrixer, and the matrixer divides the decoded image into image segments and respectively delivers the image segments to the display devices. Therefore, the display devices can display the image in cooperation.

Since all the image data is decoded by the host computer and then transmitted to the display devices for display, the display devices can be controlled to synchronously display the image data and the image data played by one of the display devices can be prevented from being asynchronous to the image data played by another one of the display devices. However, such a play method requires a high-performance host computer and a matrixer for real time decoding image data, arranging the decoded image data and respectively delivering the arranged image data to the display devices. Therefore, such a conventional digital signage constituted by a number of display devices needs a high cost, and the connection relationship among the host computer, the matrixer and the display devices is quite complicated.

### SUMMARY

The synchronizing method, according to one or more embodiments of the present disclosure, is applied to processors and display devices. Each of the processors is installed with a control program, a player program, or a combination thereof, and each of the display devices is electrically connected to one of the processors. The synchronizing method includes the following steps: defining the control program of one of the processors as a primary control program; defining a system time of the primary control program as a standard time for each of the player programs; by the primary control program sending a first play command instructing each of the player programs to start playing a piece of image data at a time position corresponding to the standard time; by the primary control program sending each of the player programs a state command instructing each of the player programs to return a first decoding position of the image data currently played; and by the primary control program determining, according to the first decoding position returned by each of the player programs, whether the image data played by each of the player programs is synchronous to another one.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic view of processors and display devices according to an embodiment of the present disclosure.

FIG. 2 is a schematic view of connections between the processors and the display devices through an internet according to an embodiment of the present disclosure.

FIG. 3 is a flowchart of a control method according to an embodiment of the present disclosure.

FIG. 4 is a flowchart of a control method according to another embodiment of the present disclosure.

FIG. 5 is a flowchart following the flowchart of the control method in FIG. 4 in the preset disclosure.

FIG. 6 is a flowchart of a control method according to yet another embodiment of the present disclosure.

FIG. 7 is a flowchart of a control method according to yet another embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

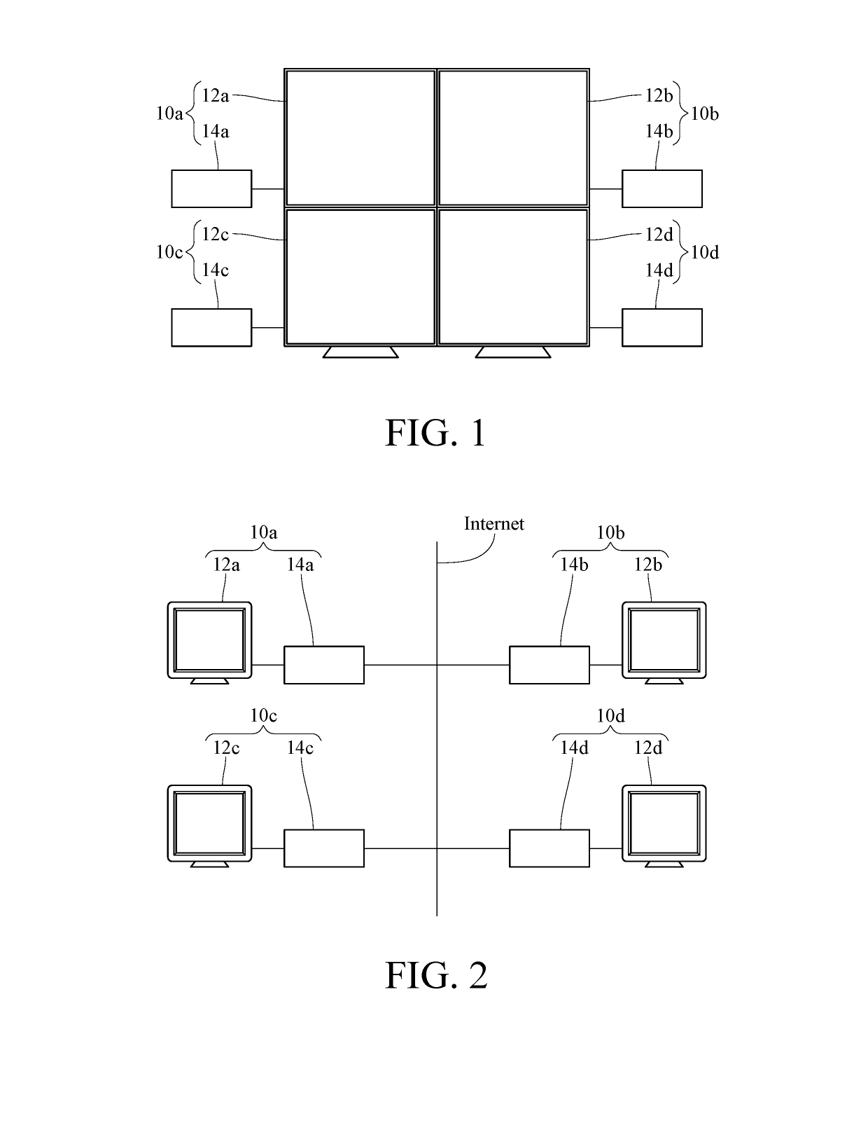

Please refer to FIG. 1 and FIG. 2. FIG. 1 is a schematic view of processors and display devices according to an embodiment of the present disclosure, and FIG. 2 is a schematic view of connections between the processors and the display devices through an internet according to an embodiment of the present disclosure. As shown in the drawings, the synchronizing method is applied to display modules 10a˜10d, and each of the display modules 10a˜10d includes display devices 12a˜12d and processors 14a˜14d. Each display device is electrically connected to one of the processors; and for example, the display device 12a is electrically connected to the processor 14a, and the connections between the other processors and display devices can be deduced by analogy. In the example as shown, the display devices 12a˜12d are arranged in a 2×2 matrix and play a respective image data. The image data respectively played by the display devices 12a˜12d can constitute a complex the whole image. That is, the display devices 12a˜12d respectively play portions of an image, and these portions are arranged in a 2×2 matrix for the whole image. In other embodiments, the display devices 12a˜12d may be arranged differently; and for example, they can be arranged irregularly, be arranged about the center of a circle, or be arranged in other suitable form. Arranging the display devices 12a˜12d in a 2×2 matrix in this embodiment is merely for exemplary illustration rather than for limiting the amount of display devices and the amount of processors, and a person of ordinary skill in the art can define the amount of display devices, the amount of processors, and the arrangement of display devices and processors according to particular requirements.

For example, the processors 14a˜14d are micro computers or other suitable devices with a wired or wireless networking function. Each of the processors can communicate with another one via an internet. Each of the processors 14a˜14d is installed with a control program, a player program, or a combination thereof. When a processor is installed with a control program, the control program is able to communicate with a player program installed in another processor via a specific network channel. Similarly, when a processor is installed with a player program, the player program is also able to communicate with a control program installed in another processor via a specific network channel.

In practice, each processor is installed with a respective control program and a respective player program; and alternately, only one processor is installed with a respective control program and a respective player program, and the rest of the processors are installed with only a respective player program. When a processor is installed with both a control program and a player program, the control program and the player program on this processor are able to communicate with each other via a specific network channel. In another embodiment, a control program may be installed on an additional host computer, and the processors 20a˜20d are installed with only a respective player program and controlled by the control program on the host computer.

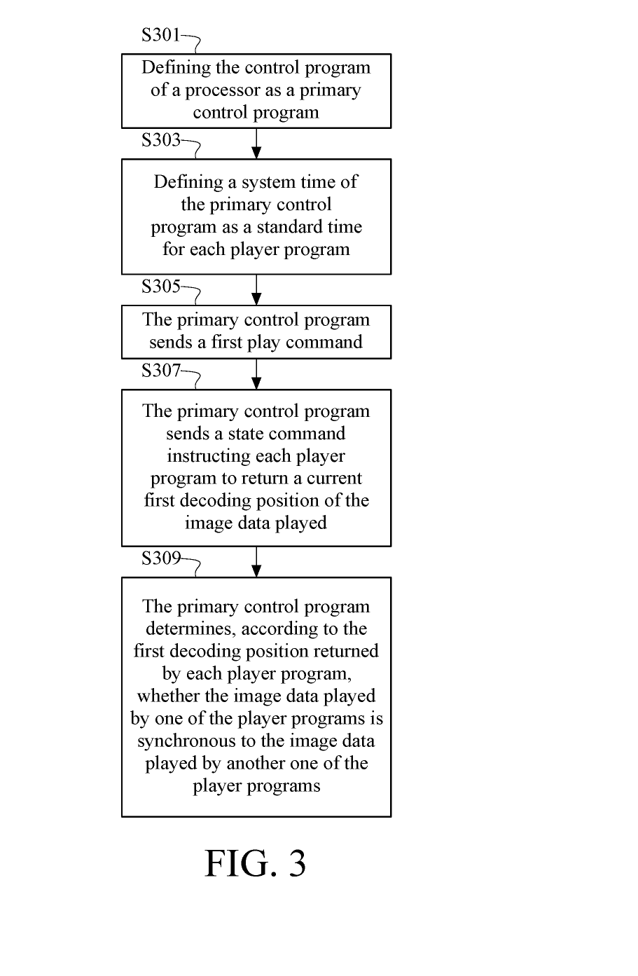

For convenience, the following embodiments are exemplarily based on a case in which the processor 14a is installed with a control program and a player program but the processors 14b˜14d are installed with only a respective player program. Please refer to FIG. 1 to FIG. 3. FIG. 3 is a flowchart of a control method according to an embodiment of the present disclosure. As shown in the drawings, in step S301, the control program on one of the processors is defined as a primary control program. In this embodiment, since only the processor 14a is installed with a control program, the control program on the processor 14a is defined as a primary control program. In step S303, each player program uses the system time of the primary control program as a standard time. The primary control program may actively provide its the system time to the player programs, or may passively provide its system time to one or more of the player programs in response to a request of the one or more of the player programs, and thus, the one or more player programs submitting the request can use the system time of the primary control program as their standard times.

In step S305, the primary control program sends a first play command that controls each player program starts playing an image data at a time position corresponding to the standard time. In an embodiment, the primary control program broadcasts such a first play command. That is, the first play command broadcasted has no destination address so that the first play command will be sent to all devices in the network. When a processor installed with a player program receives the first play command, this processor starts decoding the image data at a time position corresponding to the standard time according to the content of the first play command, and presents the content of the image data on a display device. Such a first play command indicates that a display device shall start playing an image data at the standard time that is 08:45:00 am for example, but the present disclosure is not limited thereto. The other processors not installed with any player program in the internet may ignore the first play command they receive.

In another embodiment, such a first play command includes a destination addresses. In other words, the primary control program sends a first play command to each player program requesting for playing an corresponding image data. In this case, each first play command sent includes a destination address of the corresponding player program and will be sent to the corresponding processor with the destination address, in order to control the player program on this processor to start decoding the image data at a time position of a standard time.

In practice, all image data, which will respectively be played by display devices, have respectively been stored in processors electrically connected to the display devices. In other words, an image is divided in image process into four image segments, i.e. pieces of image data, and the four image segments are respectively sent to the display modules 10a˜10d and stored in memories of the processors 14a˜14d, for example. When the display modules 10a˜10d are instructed to play their image segments, the processors 14a˜14d of the display modules 10a˜10d respectively decode the image segments so that contents of these image segments can be shown on the display devices 12a˜12d. Dividing an image can be done by one of the display modules, an additional host computer, or other suitable device, and the present disclosure does not intend to limit it. Since the image data to be played by each of the display modules 10a˜10d is obtained by dividing an image and then loaded in corresponding one of the processors 14a˜14d of the display modules 10a˜10d in advance, each of the display modules 10a˜10d can load the corresponding image data to be played and then play it without any additional high-performance device that is responsible for real time decoding and programming the image data and then delivering each of the image data to corresponding one of the display modules 10a˜10d.

In other words, in the synchronizing method in this embodiment, respectively storing image data into the display modules 10a˜10d can reduce the costs of disposition of one or more host computers and one or more matrixers in the art and also simplify the connections among the one or more host computers, one or more matrixers and the display modules 10a˜10d. However, when the display modules 10a˜10d respectively play the image data which are not decoded and then delivered by the host computer and the matrixer, image asynchronicity may occur to the display modules 10a˜10d.

To deal with such a problem, after the display modules 10a˜10d start playing the image data, the primary control program, in step S307, sends a state command to each player program to request each player program to report the current first decoding position of the corresponding image data played. For example, the first decoding position reported by the player program is the 100th window of the image data currently played, a position of the image data at 10′50″, or other information sufficient to indicate which play position the image data is currently played at. In practice, the primary control program can orderly send state commands each having a destination address. That is, the primary control program sends each player program a state command to request the corresponding player program to return the current first decoding position of the corresponding image data played. In another embodiment, the primary control program may broadcast a state command, in which no destination address exists, to all devices in the internet, and each of the processors 14a′˜14d, installed with a player program in the internet, returns its current first decoding position of the corresponding image data to the primary control program after receiving the state command.

In step S309, the primary control program determines, according to the first decoding position returned by each player program, whether the image data played by one of the player programs is synchronous to the image data played by another one of the player programs. During a time period, when the first decoding positions of the image data played by the player programs are the same, the image data played by the display modules 10a˜10d are considered synchronous. In practice, the differences between the first decoding positions of the image data played by the player programs fall in a tolerance range of synchronization time difference, the image data played by one of the display modules 10a˜10d can be considered synchronous to the image data played by another one of the display modules 10a˜10d. When the differences between the first decoding positions of the image data played by the player programs fall in a tolerance range of synchronization time difference, the image data played by one of the display modules 10a˜10d are still considered synchronous to the image data played by another one of the display modules 10a˜10d since the viewer hardly senses the lag between the image data played by the display modules 10a˜10d. The tolerance range of synchronization time difference is, for example, about 16 or 20 milliseconds.

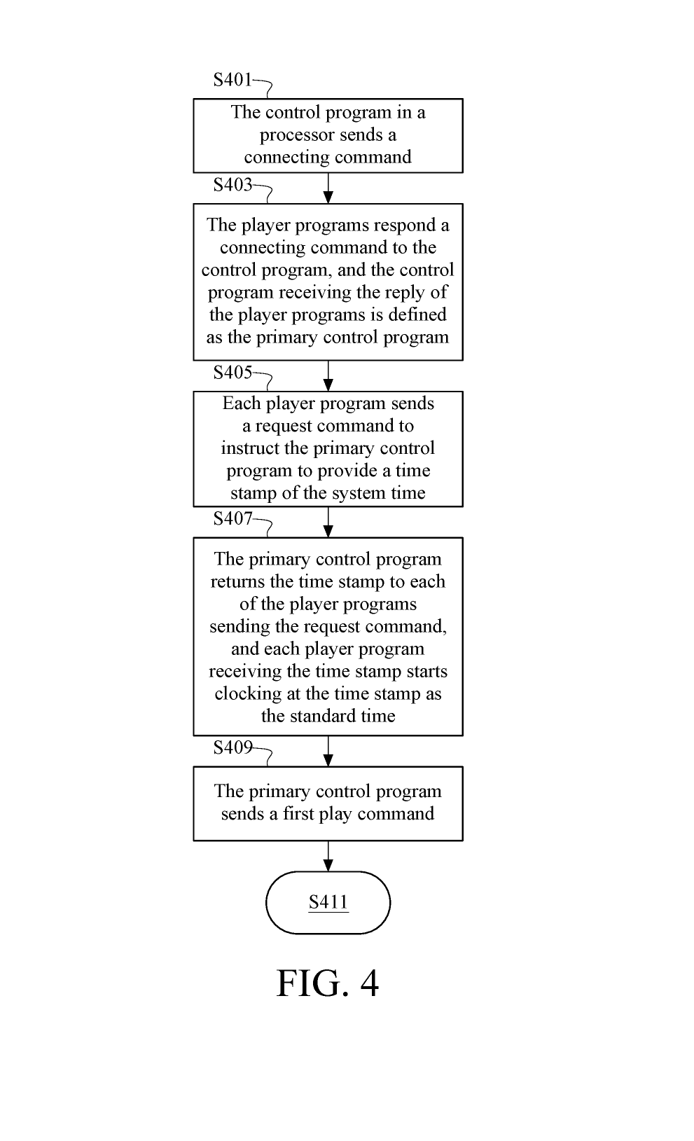

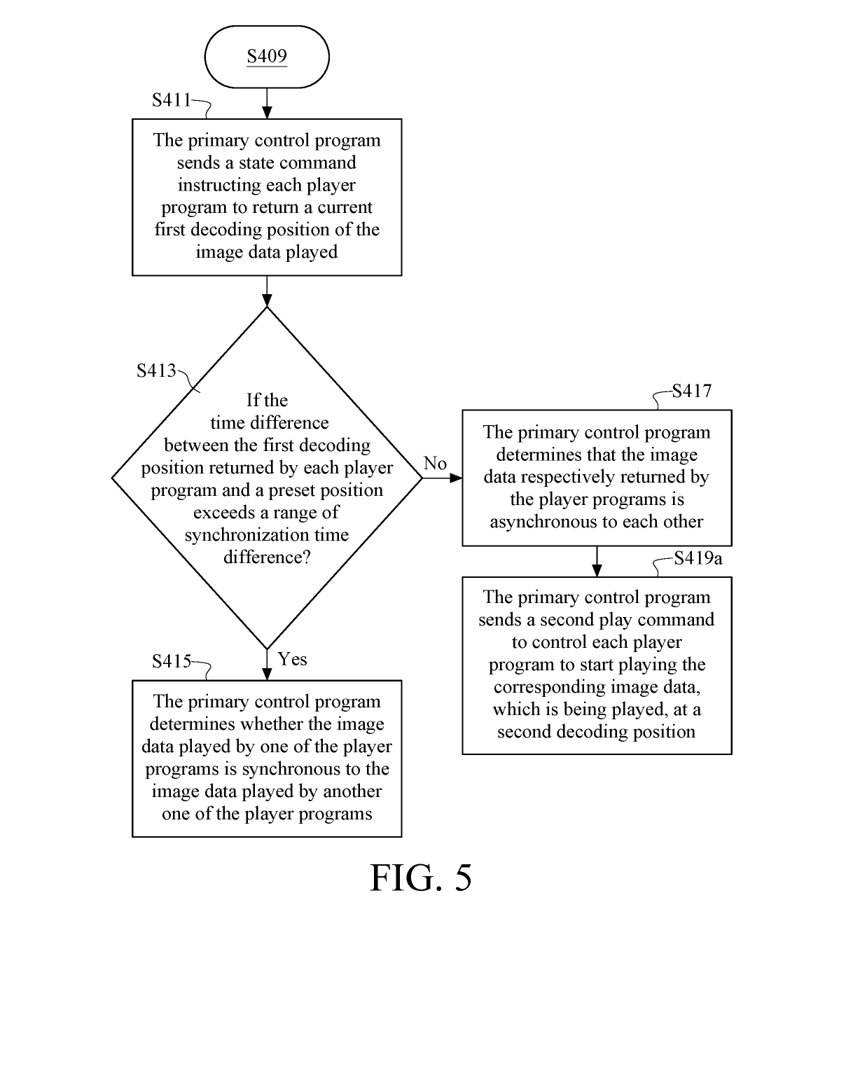

Please refer to FIG. 1, FIG. 2, FIG. 4 and FIG. 5. FIG. 4 is a flowchart of a control method according to another embodiment of the present disclosure, and FIG. 5 is a flowchart following the flowchart of the control method in FIG. 4 in the preset disclosure. As shown in the figures, this embodiment is also based on an exemplary case where the processor 14a is installed with both a control program and a player program and the processors 14b˜14d is installed with only a player program. In step S401, the control program in the processor 14a sends a connecting command to the internet. The connecting command does not include any destination address in its header but includes the network address of the processor 14a in its content. That is, the control program in the processor 14a broadcasts the connecting command indicating its network address.

In step S403, after the player programs of the processors 14a˜14d in the internet receive the connecting command and obtain the network address of the processor 14a, each of the processors 14a˜14d responds to the control program in the processor 14a with a connecting command indicating that the network address has been received. Then, connections between the player programs of the processors 14a˜14d and the control program in the processor 14a can be created, and the control program in the processor 14a is defined as a primary control program. In another exemplary case where the processors 14a˜14d are installed with both a control program and a player program, the control program in one of the processors 14a˜14d sends its network address to the other processors, and this control program sending its network address is defined as a primary control program.

Next, in step S405, the player programs of the processors 14a˜14d send the primary control program a request command to request the primary control program to provide a time stamp on the system time. In step S407, the primary control program returns a time stamp on the system time to each player program sending the request command, i.e. the player programs of the processors 14a˜14d. The player programs of the processors 14a˜14d start clocking at the received time stamp as the standard time. In other words, the processors 14a˜14d use the system time of the primary control program as their standard time.

In step S409, the primary control program sends a first play command that indicates which time position corresponding to the standard time the player program of each of the processors 14a˜14d should start playing the corresponding image data. The primary control program can broadcast the first play command, or can send the first play command after respectively inserting the network addresses of the processors 14a˜14d into the header of the first play command. After the player programs of the processors 14a˜14d receive the first play command, each of the player programs of the processors 14a˜14d starts decoding the corresponding image data at the time position indicated by the first play command and then each of the display devices 12a˜12d shows the content of the decoded image data.

After the display modules 10a˜10d start playing their respective image data, the primary control program in step S411 sends each player program a state command to control each player program to return a current first decoding position of the corresponding image data. The primary control program may orderly send the player programs a state command to request the corresponding player program to return the current first decoding position of the corresponding image data, or may broadcast a state command to instructing the processors 14a˜14d, which are installed with a player program, in the internet to return the current first decoding positions of the respective image data to the primary control program.

When the primary control program receives the first decoding position from each player program, the primary control program determines whether the time difference between the first decoding position returned by each player program and a preset position exceeds a range of synchronization time difference, as shown in step S413. Therefore, the determination of whether the image data played by one of the player programs is synchronous to the image data played by another one of the player programs can be made. In step S415, when the time difference between the first decoding position returned by each player program and the preset position is within the range of synchronization time difference, the image data respectively played by one of the player programs are determined as being synchronous to the image data played by another one of the player programs. In step S417, when all the time differences between the first decoding positions returned by the player programs and the preset position are not within the range of synchronization time difference, the image data respectively returned by the player programs is asynchronous to each other. To deal with this situation, the primary control program sends a second play command to control each player program to start playing the image data, which is being played, at a second decoding position in an embodiment, as shown in step S419a.

For example, when the first decoding position returned by one or more of the player programs is not in the range of synchronization time difference during about the 10th minute after the primary control program requests the player programs to start playing their image data, the primary control program will determine that the image data played by one of the player programs are not synchronous to the image data played by another one of the player programs, and will send a second play command to control each player program to resume playing the corresponding image data starting at a decoding position after the 10th minute, e.g. starting at the ninth or eleventh minute of the corresponding image data. Through instructing each player program to reset a decoding position at which playing a corresponding image data is restarted, a player program asynchronous to other ones will be able to become synchronized with them. Therefore, an image played by the display devices in cooperation may be prevented from having a time lag between its image sections. For example, the range of synchronization time difference is not limited to about 16 or 20 milliseconds.

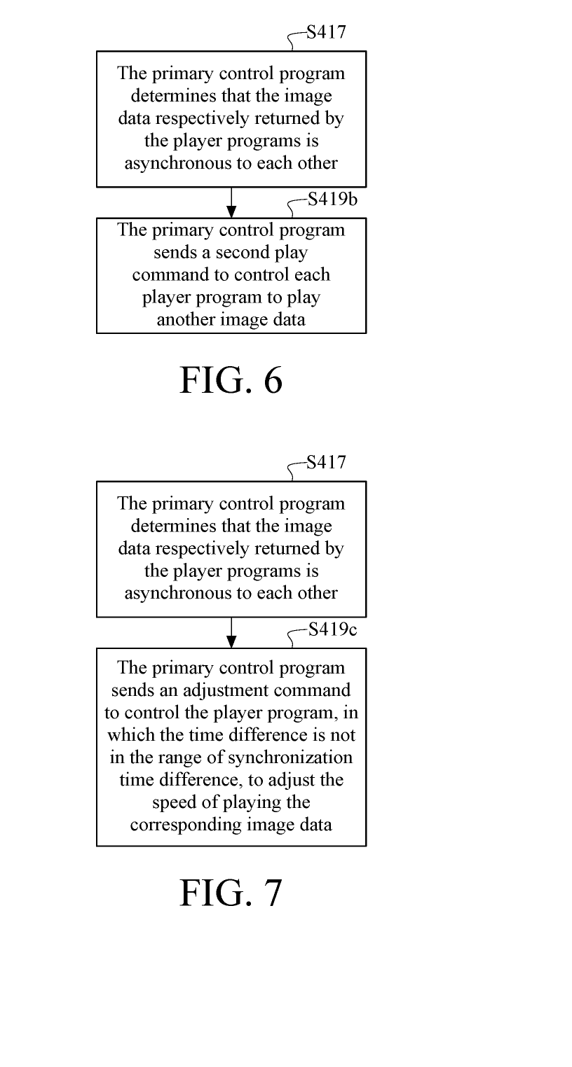

Please refer to FIG. 4 to FIG. 6. FIG. 4 is a flowchart of a control method according to another embodiment of the present disclosure, and FIG. 6 is a flowchart of a control method according to yet another embodiment of the present disclosure when the image data played by one of the player programs is synchronous to the image data played by another one of the player programs. Steps S401 to S413 in step S417 that is shown in FIG. 6 are the same as those in the previous embodiment, and thus, they are not shown in this figure and not illustrated hereafter. In this embodiment, when the primary control program determines that the image data played by one of the player programs is synchronous to the image data played by another one of the player programs, in step S419b, the primary control program sends a second play command to control each player program to directly terminate the corresponding image data that is being played, and start play another image data, e.g. a next image data in a playlist.

Please refer to FIG. 4, FIG. 5 and FIG. 7. FIG. 7 is a flowchart of a control method according to yet another embodiment of the present disclosure. FIG. 7 also illustrates another exemplary case in which image data played by player programs are not synchronous. Steps S401 to S417 are the same as those in the previous embodiment and thus, are not explained hereafter. In this embodiment, when the primary control program determines that the image data played by one of the player programs are not synchronous to the image data played by another one of the player programs, the process proceeds to step S419c, in which the primary control program sends an adjustment command to control the player program, whose time difference is not in the range of synchronization time difference, to adjust the speed of playing the corresponding image data. For example, if the first decoding position returned by one of the player programs lags the preset position, an adjustment command will be sent to this player program to instruct it to speed up playing the corresponding image data, so that the play speed is restored to normal after a current position of playing the image data is speeded up to the preset position.

In the previous embodiments, if one or more of the player programs, instructed by the primary control program to return their current first decoding positions of the corresponding image data played, do not return anything to the primary control program, the primary control program will also consider that the image data played by one of the player programs is asynchronous to the image data played by another one of the player programs, and will perform step S419a, S419b or S419c again to reset which position each player program should start playing its corresponding image data at, in order to synchronize all the player programs with each other for synchronously playing their image data.

To sum up, in the synchronizing method for display devices in the present disclosure, each display device is electrically connected to a processor that is installed with a control program or a player program, and the control program is defined as a primary control program that can command each player program to start playing corresponding image data at a time position. During a time period that the player programs play respective image data, the primary control program further regularly requests each player program to return a decoding position of the corresponding image data currently played, in order to determine whether the image data played by one of the player programs is asynchronous to the image data played by another one of the player programs. Each pair of a display device and a processor can decode a respective image data and display the content of the decoded image data. By instructing the interaction between the primary control program and the player programs, the image data may be synchronously played without any high-performance host computer and matrixer that are used in the art to decode image data and program and deliver the decoded image data. In this way, the present disclosure may be prevented from having a high cost and a complex connection relationship.

1. A synchronizing method, applied to processors, each of which is installed with a control program, a player program or a combination thereof, and display devices, each of which is electrically connected to one of the processors, and the synchronizing method comprising:
defining the control program of one of the processors as a primary control program;
defining a system time of the primary control program as a standard time for each of the player programs;
by the primary control program sending a first play command instructing each of the player programs to start playing a piece of image data at a time position corresponding to the standard time;
by the primary control program sending each of the player programs a state command instructing each of the player programs to return a current first decoding position of the image data played; and
by the primary control program determining, according to the first decoding position returned by each of the player programs, whether the image data played by one of the player programs is synchronous to the image data played by another one of the player programs.

2. The synchronizing method according to claim 1, wherein the defining the control program of one of the processors as the primary control program comprises:
by the control program of one of the processors sending a connecting command;
by the player programs replaying to the connecting command sent by the control program; and
defining the control program, which receives a reply from the player programs, as the primary control program.

3. The synchronizing method according to claim 2, wherein one of the processors is installed with the player program and the control program that is defined as the primary control program, and the rest of the processors are installed with the player program.

4. The synchronizing method according to claim 1, wherein the defining the system time of the primary control program as the standard time for each of the player programs comprises:
by each of the player programs sending the primary control program a request command that controls the primary control program to provide a time stamp of the system time;
by the primary control program returning the time stamp to each of the player programs sending the request command; and
by each of the player programs receiving the time stamp and starting clocking at the time stamp as the standard time.

5. The synchronizing method according to claim 1, wherein the determining whether the image data played by one of the player programs is synchronous to the image data played by another one of the player programs, according to the first decoding position returned by each of the player programs, by the primary control program comprises:
determining whether a time difference between the first decoding position returned by each of the player programs and a preset position falls in a range of synchronization time difference;
determining that the image data played by one of the player programs is synchronous to the image data played by another one of the player programs, when the time difference between the first decoding position returned by each of the player programs and the preset position falls in the range of synchronization time difference; and
determining that the image data played by one of the player programs is asynchronous to the image data played by another one of the player programs, when the time difference between the first decoding position returned by one of the player programs and the preset position exceeds the range of synchronization time difference.

6. The synchronizing method according to claim 5, wherein when the image data played by one of the player programs is asynchronous to the image data played by another one of the player programs, the synchronizing method further comprises:
by the primary control program sending a second play command instructing each of the player programs to start playing the corresponding image data at a second decoding position.

7. The synchronizing method according to claim 5, wherein when the image data played by one of the player programs is asynchronous to the image data played by another one of the player programs, the synchronizing method further comprises:
by the primary control program sending a second play command instructing each of the player programs to play another image data.

8. The synchronizing method according to claim 5, wherein when the image data played by one of the player programs is asynchronous to the image data played by another one of the player programs, the synchronizing method further comprises: by the primary control program sending an adjustment command instructing the processor, in which the time difference exceeds the range of synchronization time difference, to adjust a speed of playing the image data.

9. The synchronizing method according to claim 1, wherein when the player programs do not return the first decoding position, the primary control program determines that the image data played by one of the player programs is asynchronous to the image data played by another one of the player programs.
